(19) United States
(12) Patent Application Publication
(10) Pub. No.: US 2011/0068164 A1
(43) Pub. Date: Mar. 24, 2011

(54) Method and Apparatus for Barcode and Position Detection

(75) Inventors: Nigel Peter Hanson, Christchurch (NZ); James M. Janky, Sunnyvale, CA (US)

(73) Assignee: Trimble Navigation Limited, Sunnyvale, CA (US)

(21) Appl. No.: 12/566,093

(22) Filed: Sep. 24, 2009

(51) Int. Cl. G06F 17/00; G06K 7/10

(52) U.S. Cl. 235/375; 235/462.09; 235/462.11

(57) ABSTRACT

Method and apparatus for detecting barcode data of at least one item of interest. In one embodiment, a method includes detecting a barcode target, by an imaging device, associated with an item located at a position of interest. The method further includes decoding the barcode target to extract data associated with the item, determining position data for the position of interest and displaying the data associated with the item and the position data for a user.

### FIELD OF THE INVENTION

The present invention relates in general to surveying and more particularly to detecting a barcode target associated with an item at a position of interest and determining position data for the position of interest.

### BACKGROUND

Conventional methods of surveying typically employ ground markers, such as stakes, to mark a location. Marking locations may be performed by permanent or temporary markers such as wooden stakes or painted symbols. Unfortunately, these ground markers typically provide limited information. Additionally, devices currently available for surveying and identifying positions of interest are not configured to distinguish between the conventional markers. For example, many surveying devices employ a surveying pole placed at the location of a conventional survey stake. Because these conventional methods are typically performed with a surveying pole, the conventional systems for performing surveying and positioning measurements do not require survey markers to provide additional information. One disadvantage of such an approach may be difficulty in identifying surveying marks. Another disadvantage may be increased time required for performing a surveying measurement.

Thus, there is a need in the art for a method and apparatus for improved measurement and identification of items of interest.

### BRIEF SUMMARY OF THE INVENTION

Disclosed and claimed herein are a method and apparatus for detecting barcode data of at least one item of interest. In one embodiment, a method includes detecting a barcode target, by an imaging device, associated with an item located at a position of interest. The method further includes, decoding the barcode target to extract data associated with the item, determining position data for the position of interest and displaying the data associated with the item and the position data for a user.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a simplified block diagram of a device configured for barcode detection according to one or more embodiments of the invention;

FIGS. 2A-2B depict embodiments of the device of FIG. 1 according to one or more embodiments of the invention;

FIG. 3 depicts a process according to one or more embodiments of the invention;

FIG. 4 depicts a process according to one or more embodiments of the invention;

FIG. 5 depicts a process according to one or more embodiments of the invention; and

FIG. 6 depicts a graphical representation of a display window according to one embodiment of the invention.

### DETAILED DESCRIPTION OF EXEMPLARY EMBODIMENTS

One aspect of the present invention is directed to detecting a barcode target for an item located at a position of interest. According to one embodiment, one or more items may be marked with a barcode target, including but not limited to a surveying stake, a permanent marker, a mobile device, etc. A surveying measurement and/or positioning measurement may then be performed for the position of interest. As used herein, a position of interest may refer to a particular global position or target area. For example, a position of interest may relate to a position marked by a surveying marker. Similarly, the position of interest may relate to the location of a movable item. Detection and decoding of the barcode target may be performed by a barcode target device. In one embodiment, measurement data may be stored and/or displayed to a user based on data encoded in a barcode target. Further, one or more measurements may be performed following detection and identification of a barcode target.

The present disclosure further relates to a device configured for detection of a barcode target. In one embodiment, the device includes an imaging device configured to detect one or more barcode targets. The device may be configured to display data to a user based on one or more barcodes and provide decoded data to a user. According to another embodiment, the device may be configured to determine position data for the position of interest. Measurement results may be compared to decoded barcode data to determine changes associated with the position of interest. For example, a change in elevation, and/or global position, of the position of interest may be determined by the device. The device may further include a wired and/or wireless link to a processing station or server for post-processing of collected surveying data. To that end, the device may provide automated monitoring of an item at a position of interest.

Another aspect of the invention is directed to a process for identifying one or more items of interest based on a detected barcode target. According to one embodiment, a device configured for detection of a barcode target may be configured to display a target window identifying a detected barcode. The device may be configured to decode a barcode target based on a user selection.

When implemented in software, the elements of the invention are essentially the code segments to perform the necessary tasks. The program or code segments can be stored in a processor-readable medium. The “processor-readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, etc. The code segments may be downloaded via computer networks such as the Internet, Intranet, etc.

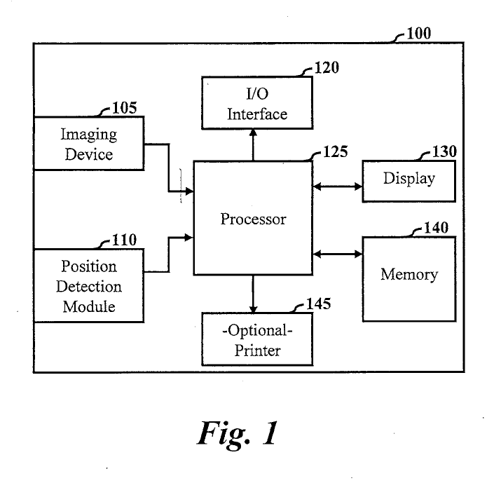

Referring now to the drawings, FIG. 1 depicts a simplified block diagram of a device for detection of a barcode target according to one or more embodiments of the invention. As shown in FIG. 1, device 100 includes an imaging device 105 coupled to processor 125. Imaging device 105 may be configured to detect a barcode target associated with an item located at a position of interest. In one embodiment, imaging device 105 may relate to a charge-coupled device (CCD), CMOS image sensor, active pixel sensor, laser scanning device (e.g., long range barcode scanner), etc. One advantage of the invention may be that imaging device 105 may allow for detection and imaging of one or more barcode targets from a distance. For example, imaging device 105 may be configured for a range of 1 to 150 feet. However, it also may be appreciated that imaging device 105 may be configured to operate in other ranges, using one or more different optical systems, such as an optical telescope in a surveyor's total station.

According to another embodiment, device 100 can determine position data associated for a position of interest. As shown, device 100 includes a position detection module 110. Position detection module 110 may include an angle sensor to determined angular position of a position of interest in relation to device 100 and a distance sensor to detect distance to the position of interest. Output from position detection module 110 may be collected by processor 125 to determine at least one of an elevation, grade, and surveying data in general. Alternatively, or in combination, position detection module 110 may be configured to determine global positioning coordinates (e.g., Global Navigation Satellite Systems (GNSS), Global Positioning System (GPS), Galileo Satellite Navigation System, or the Compass Global Satellite Navigation System).

Processor 125 can output measurement data and/or data received from imaging device 105 using I/O interface 120. According to another embodiment, processor 125 can be any type of processor such as a microprocessor, field programmable gate array (FPGA) and/or application specific integrated circuit (ASIC). Measurement data can be stored by memory 140 wherein memory 140 relates to one of a ROM and RAM memory. It may also be appreciated that measurement data collected by device 100 may be presented to a user by display 130.

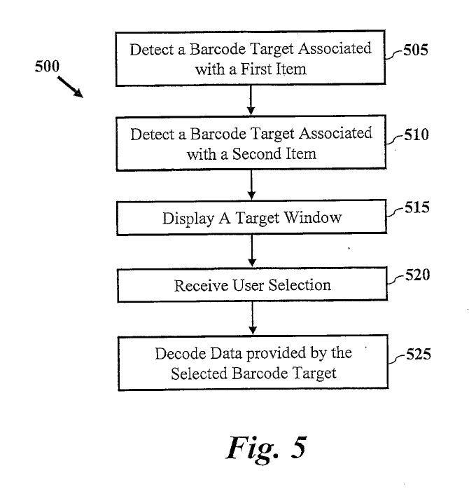

According to another embodiment, device 100 may relate an optical total station, such as the Trimble™ VX Spatial Station. The Trimble™ VX Spatial Station can employ a camera and/or electronic telescope as imaging device 105 to observe a target area where items of interest are located. In certain embodiments, a barcode scanner may be electrically coupled to one of the telescope display and the camera display to detect a barcode target in a target area. In this way, the recognition range of barcodes on a distant target may be increased dramatically. As a result, device 100 can identify barcode targets at greater distances. Device 100 may further be configured to detect barcode data of at least one item of interest as will be described in more detail below with respect to FIG. 5.

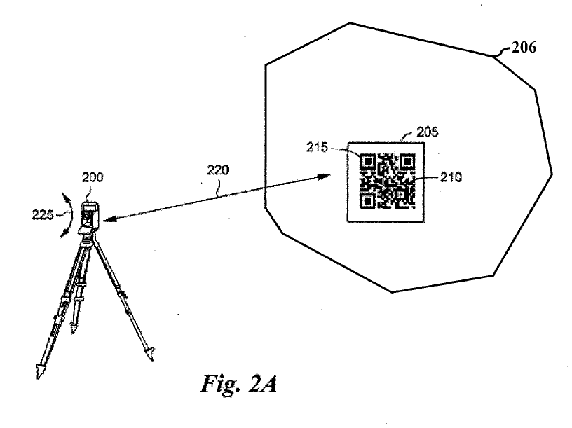

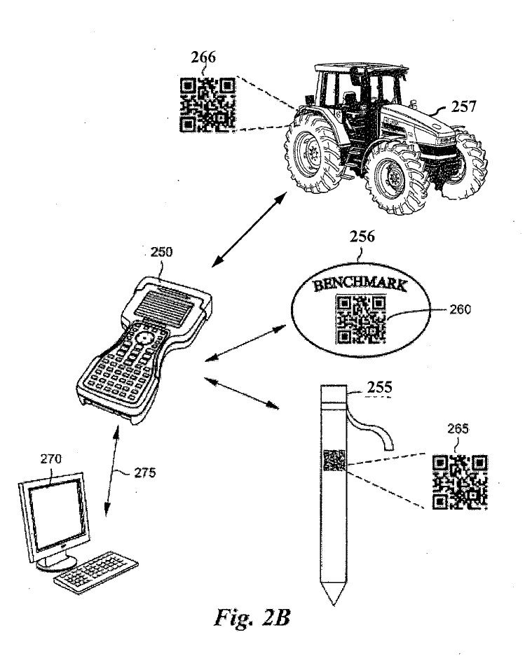

In yet another embodiment, device 100 may relate to a Geographic Information System (GIS) device which may be configured to detect one or more barcode targets as will be discussed in more detail below with respect to FIG. 2B.

As described above, device 100 may be configured to determine surveying measurements for a position of interest labeled with a barcode. It may also be appreciated that position determination tool 100 can determine at least one surveying measurement for a position of interest and generate a barcode using optional printer 145. Optional printer 145 may be configured to print a barcode label which may be generated in the field for a position of interest.

Referring now to FIGS. 2A-2B, graphical representations of the device of FIG. 1 are shown according to one or more embodiments of the invention. Referring first to FIG. 2A, barcode detection device is shown as a total station according to one embodiment. Total station 200 may be configured to perform a surveying measurement and/or detect barcode target 210 associated with a position of interest 205. For example, total station 200 may be configured to determine a distance, shown as 220, to the position of interest 205. Further, total station 200 can determine an angular offset, shown as 225, to the position of interest in relation to total station 200. As shown in FIG. 2A, barcode target 210 is depicted as a two-dimensional barcode. However, it may also be appreciated that barcode target 210 can be any type of barcode, such as a matrix code, monochromatic barcode, color barcode and any type of barcode in general. It should also be appreciated that barcode target 210 can include position mark 215 which may be used by total station 200 to decode data. For example, position mark 215 may provide a reference to determine the orientation of barcode target 210. As such, total station 200 can provide omni-directional decoding of barcode targets.

Barcode target 210 may be fixed or attached to item 206. Data encoded in barcode target 210 may include an identification and feature information for item 206. According to another embodiment of the invention, total station 200 may be configured to detect a barcode 210 from a distance. Data encoded in barcode 210 may be decoded by total station 200 to provide an orientation of the total station. As such, total station 200 can then use decoded information to provide directional information to the user of the total station 200.

According to another embodiment, barcode target 210 can provide a plurality of information types. For example, barcode target 210 may include an identification number assigned by a surveying tool or a predefined identifier, such as a government issued benchmark number. Similarly, barcode target 210 can include data such as a date or time relating to a time and/or date that the barcode is encoded. The date value can be useful when determining a rate of movement for a position of interest. Latitude and longitude coordinates relating to global position data and/or latitude and longitude coordinates may further be decoded from a barcode target. Additionally, barcode target 210 may include feature information including data entered by a user related to the position of interest. For example, the location of a utility service in the vicinity of a surveying mark may be indicated. In addition, information related to a position of interest that the device is required to locate and measure.

Total station 200 may include a position detection module (e.g., position detection module 110) configured to determine position data for the position of interest 205. In one embodiment, total station 200 may be configured to determine position data by employing Global Position Satellite (GPS) system data. Additional positioning satellite system data which may be employed includes GLONASS, Galileo, and Compass, the Global Navigation Satellite System (GNSS). Accordingly, total station 200 may include and/or relate to equipment manufactured by Trimble Navigation Limited, the assignee of this application, and include products designed for surveying applications and Geographical Information System (GIS) applications. Exemplary equipment which may be employed includes the Trimble™ S6, VX Spatial Station, and the family of GeoExplorers used in GIS applications. Other techniques employing a combination of terrestrial optical survey and satellite-based position determination are also well known in the arts. The following patents are incorporated by reference herein in their entirety: U.S. Pat. No. 5,471,218; U.S. Pat. No. 5,923,287; and U.S. Pat. No. 6,529,828.

According to another embodiment of the invention, total station 200 may be configured to detect barcodes of various dimensions. In certain embodiment, the dimensions of barcode 210 can limit the amount of data which may be encoded into the barcode. However, it should be appreciated that barcode 210 may be produced having a variety of dimensions. When used as a surveying target, barcode 210 may conform to a predefined surveying target size. The following table provides exemplary values of the maximum number of characters which can be encoded by barcode 210 according to one embodiment of the invention. Although the values presented relate to an exemplary maximum number of characters encoded by barcode data, it may be appreciated that barcode 210 may be decoded with less characters. It should also be appreciated that total station 200 could decode a barcode target having data exceeding the exemplary values.

TABLE 1
BARCODE DATA CAPACITY

| | |
|---|---|
| Numeric | Max. 7,089 characters |
| Alphanumeric | Max. 4,296 characters |
| Binary (8 bits) | Max. 2,953 characters |
| Kanji, full-width Kana | Max. 1,817 characters |

According to another embodiment of the invention, total station 200 may be configured to perform a surveying measurement and/or detect a barcode 210 from a distance to reduce risk associated with performing a surveying measurement in a high risk site, such as earth movement. Further, barcode 210 may be produced at relatively low cost. In that fashion, monitoring a position of interest in a high risk site may be performed by total station 200.

Referring now to FIG. 2B, device 250 (e.g., device 100) is presented as another embodiment of total station 200. As shown in FIG. 2B, device 250 can detect a barcode associated with a variety of surveying markers. Device 250 is shown in FIG. 2B as being a field instrument which can be used to detect a barcode target from close proximity according to one embodiment of the invention. As such, device 250 may include a barcode scanner and/or imaging device (e.g., imaging device 105) configured to detect barcode 255 coupled to a surveying mark 265, barcode 260 coupled to a surveying mark 256 and/or barcode 266 coupled to a mobile machine 257. As shown in FIG. 2B, surveying marks 255 and 256, are shown as a surveying stake and a benchmark, respectively. Machine 257 is illustrated as a tractor, however, it should also be appreciated that mobile machine 257 can relate to other types of mobile devices and is not limited to tractors. It should also be appreciated that device 250 can detect barcodes coupled to any type of surveying marker in general.

According to another embodiment, device 250 may relate to a Geographic Information System (GIS) unit which may be a handheld unit. In that fashion, one or more detected barcode targets may be decoded by device 250 wherein the decoded data may be used by one or more applications of the GIS.

Detection of barcodes 260, 265 and/or 266 may be used to determine position of device 250 by decoding data associated with the barcodes. According to another embodiment of the invention, device 250 can transmit detected barcodes to a central processor 270 for collection and processing over communication link 275. Communication link 275 may be one of a wired or wireless data link. Device 250 may further be configured to store data for items 255, 256 and 257.

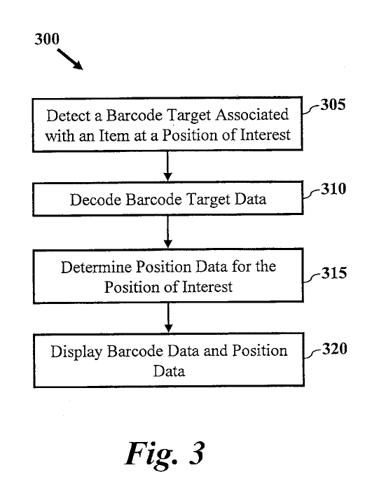

Referring now to FIG. 3, a process is shown for detecting barcode data according to one or more embodiments of the invention. Process 300 is shown for decoding barcode data according to one embodiment of the invention. Process 300 may be initiated with detection of a barcode target associated with an item located at a position of interest, at block 305, by an imaging device (e.g., imaging device 105). Data encoded in the barcode target may be decoded at block 310. A processor of the barcode detection device may be configured to capture an image of the target barcode for processing to decode the barcode. Decoded data may be stored in a memory (e.g., memory 140). At block 315, the device can determine position data for the position of interest. In one embodiment, position data may be determined by performing at least one of a surveying measurement and global positioning measurement. Position data can relate to one or more of location coordinates, elevation, grade, GNSS position data, surveying data and global position data. In certain embodiments, a surveying measurement can be performed for the position of interest at block 315 to determine an elevation, grade or spatial position of the position of interest. The surveying measurement may be compared to data decoded from the barcode to determine any movement or changes associated with the position of interest. In that fashion, process 300 may be used to monitor earth movement and/or equipment movement. The decoded data and position data may be presented by a display (e.g., display 130) in block 320.

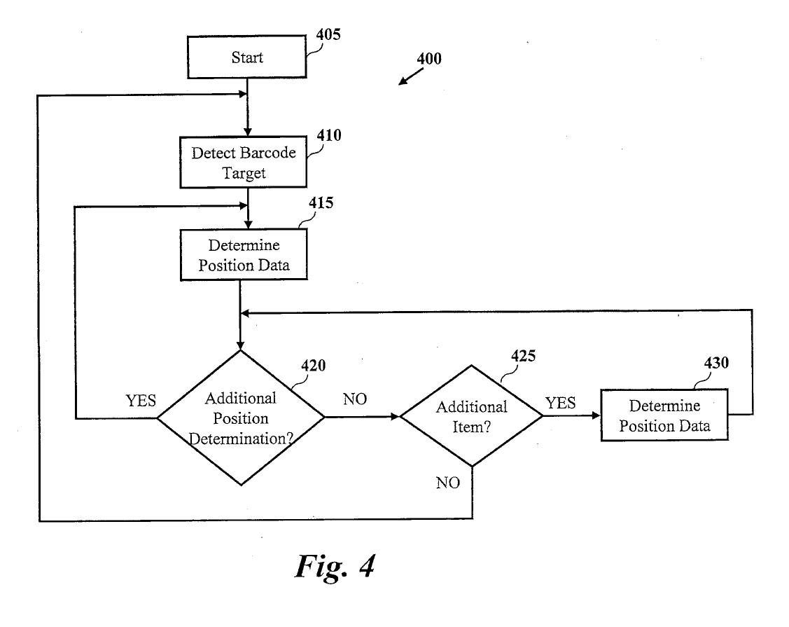

Referring now to FIG. 4, a process is depicted for detecting barcode data of at least one item of interest according to one or more embodiments of the invention. Process 400 may be initiated at start block 405 by a user to for a target area. At block 410 a barcode detection device (e.g., device 100) can detect one or more barcode targets for a target area. The device proceeds to determine position data at block 415. At decision block 420, the device can check if additional position data is to be determined. Additional position data may be determined for an item based on one or more user and/or device settings. In that fashion, process 400 can monitor movement of one or more items. When additional position data is to be corrected (“YES” path out of decision block 420) the device can determine position data at block 415. When additional position data is not required (“NO” path out of decision block 420) process 400 proceeds to check if additional items require analyzing at decision block 425.

In one embodiment, the device may prompt a user when multiple barcode targets are detected in a target area. When process 400 detects an additional barcode target, (“YES” path out of decision block 425) the device can determine position data at block 430. When no additional barcode targets are detected, (“NO” path out of decision block 425) process 400 can search another target area.

Referring now to FIG. 5 a process is depicted for selecting a barcode target according to one embodiment of the invention. Process 500 may be employed by a barcode detection device (e.g., device 100) when a plurality of barcode targets are detected in a target area. For example, process 500 may be performed by one or more of a total station and GIS configured to detect one or more barcode targets. Process 500 may be initiated by detecting a barcode target associated with a first item at block 505. Process 500 may detect a barcode target associated with a second item at block 510. The device can display one or more of a listing and graphical representation of the barcode targets. At block 515, the device can display a target window identifying one of the barcode targets. The device may be configured to receive user input for selection of a barcode target at block 520. At block 525, the device can decode data of a selected barcode target. Process 500 may further include displaying decoded barcode information and position data for one or more barcode targets. In certain embodiments, one or more devices, such as a total station and GIS, may be programmed to operate according to process 500.

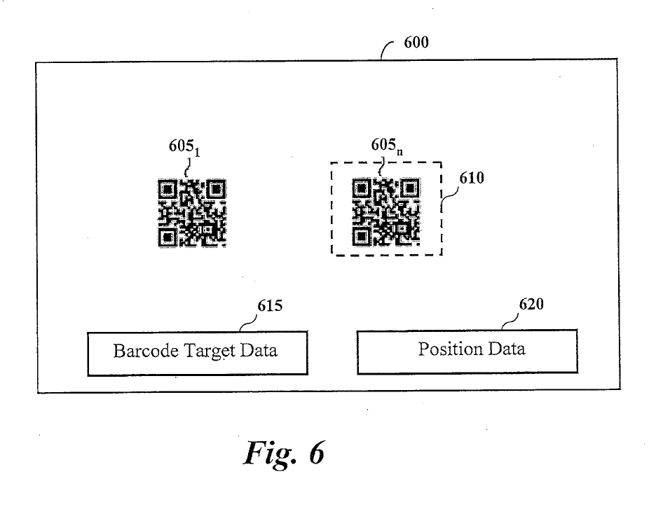

Referring now to FIG. 6, a graphical representation of a device display window is depicted according to one embodiment of the invention. Display window 600 may be displayed by a device (e.g., device 100). Display window 600 may provide barcode targets 605₁₋ₙ and decoded barcode data 615 and position data 620. Display window 600 may further display target window 610 identifying a barcode target. The display (e.g., display 130) may be configured to select one or more barcode targets with target window 610 based on user input and/or device settings. Although barcode targets 605₁₋ₙ are shown as graphical representations in FIG. 6, it should also be appreciated that display window may provide barcode targets 605₁₋ₙ as a list.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

1. A method for detecting barcode data of at least one item of interest, the method comprising the acts of:
detecting a barcode target, by an imaging device, associated with an item located at a position of interest;
decoding the barcode target to extract data associated with the item;
determining position data for the position of interest; and
displaying the data associated with the item and the position data for a user.

2. The method of claim 1, wherein the barcode target is one of a two-dimensional barcode, a matrix code and an encoded pattern.

3. The method of claim 1, wherein said data associated with the item of interest includes at least one of an identification of the item and feature information associated with the item.

4. The method of claim 1, wherein the position data relates to at least one of location coordinates, elevation, grade, Global Navigation Satellite Systems (GNSS) position data, surveying data and global position data.

5. The method of claim 1, wherein determining position data comprises performing at least one of a surveying measurement and global positioning measurement.

6. The method of claim 1, wherein decoding the barcode target comprises decoding by a barcode scanner of one of a total station and handheld geographic information system.

7. The method of claim 1, further comprising generating a data record for the item of interest, to store the data associated with the item and the position data.

8. The method of claim 1, further comprising determining position data for a second position of interest associated with the item and displaying position data for the second position.

9. The method of claim 1, further comprising detecting a second barcode target associated with a second item and determining position data for the second barcode target.

10. The method of claim 1, further comprising displaying a target window on the display to mark the barcode target.

11. The method of claim 1, further comprising receiving a user selection and decoding the barcode target based on the user selection.

12. The method of claim 1, wherein the imaging device relates to one of a barcode scanner and electronic telescope of a total station.

13. A device configured for barcode target detection comprising:
a display;
an imaging device configured to detect a barcode target associated with an item located at a position of interest;
a position detection module configured to determine position data for the position of interest; and
a processor coupled to the display, the imaging device and the position detection module, the processor configured to:
decode the barcode target to extract data associated with the item; and
output the data associated with the item and the position data to the display for a user.

14. The device of claim 13, wherein the barcode target is one of a two-dimensional barcode, a matrix code and an encoded pattern.

15. The device of claim 13, wherein said data associated with the item of interest includes at least one of an identification of the item and feature information associated with the item.

16. The device of claim 13, wherein the position data relates to at least one of location coordinates, elevation, grade, Global Navigation Satellite Systems (GNSS) position data, surveying data and global position data.

17. The device of claim 13, wherein the position detection module performs at least one of a surveying measurement and global positioning measurement.

18. The device of claim 13, wherein the processor is further configured to generate a data record for the item of interest, to store the data associated with the item and the position data.

19. The device of claim 13, wherein the position detection module determines position data for a second position of interest associated with the item and displaying position data for the second position.

20. The device of claim 13, wherein the imaging device detects a second barcode target associated with a second item and determining position data for the second barcode target.

21. The device of claim 13, wherein the display is configured to display a target window to mark the barcode target.

22. The device of claim 13, wherein the processor is further configured to receive a user selection and decode the barcode target based on the user selection.

23. The device of claim 13, wherein the device relates to one of a total station and handheld geographic information system.

24. The device of claim 13, wherein the imaging device relates to one of a barcode scanner and electronic telescope of a total station.

25. The method of claim 1, wherein detecting a barcode target relates to detection of the barcode target located a distance within a range of 1 to 150 feet.

26. The method of claim 1, further comprising transmitting one or more of the data associated with the item located at the position of interest and the position data for the position of interest over a wireless link.

27. The method of claim 1, further comprising monitoring earth movement based on one or more of the data associated with the item located at the position of interest and the position data for the position of interest.

28. The device of claim 13, wherein detection of a barcode target relates to detection of the barcode target located a distance within a range of 1 to 150 feet.

29. The device of claim 13, wherein the device is further configured to transmit one or more of the data associated with the item located at the position of interest and the position data for the position of interest over a wireless link.

30. The device of claim 13, wherein the device is further configured to monitor earth movement based on one or more of the data associated with the item located at the position of interest and the position data for the position of interest.
